(19) United States
(12) Patent Application Publication
(10) Pub. No.: US 2026/0366271 A1
(43) Pub. Date: Nov. 19, 2026

(54) INTEGRATED ENERGY-STORING RATCHET SYSTEM WITH COUNTING RELEASE MECHANISM

(71) Applicant: Waumer Oy, Helsinki (FI)

(72) Inventors: Mikolaj BANKA, Espoo (FI); Reijo FINNILÄ, Helsinki (FI); Tommi SYTELÄ, Espoo (FI); Oguzhan TASKIN, Vantaa (FI)

(73) Assignee: Waumer Oy, Helsinki (FI)

(21) Appl. No.: 19/670,934

(22) Filed: May 7, 2026

(30) Foreign Application Priority Data
May 14, 2025 (FI) 20253191

(51) Int. Cl. E03B 7/07; F03G 1/02; F16D 43/202; G16Y 10/35; H02K 7/18

(52) U.S. Cl. CPC E03B 7/072; F03G 1/022; F16D 43/2028; H02K 7/1853; G16Y 10/35

(57) ABSTRACT

The invention solves the problem how to power an IoT water pipeline network component without utilizing external sources of electricity through accumulating mechanical energy in a spring, from multiple pressure variations, occurring over time in the plumbing system. This energy is then released when it reaches a predetermined threshold and converted to electrical energy with an electromagnetic generator. The pressure variations are typically collected with a piston-spring-rolling diaphragm actuator, metal bellow actuator, or a Bourdon tube.

### CROSS-REFERENCE TO RELATED APPLICATIONS

This application claims the benefit of priority to Finnish application no. 20253191 filed on May 14, 2025. The aforementioned related patent application is herein incorporated by reference in its entirety.

### TECHNICAL FIELD OF INVENTION

The invention relates to water piping systems. More particularly, the invention relates to water consumption measurement systems and even more particularly, registering and utilizing small pressure differences for water consumption measurement systems.

### BACKGROUND

Modern water metering systems are expected to operate reliably, and with minimal maintenance. Traditional mechanical water meters, while robust, do not by default support data collection or remote communication. Remote readable meters solve this issue by having electronic circuits to monitor water usage and transmit the data. The issue with this approach is relatively short battery life, and thus product life (when compared to traditional, mechanical meters) and the need for service work to replace the batteries or the whole meter from time to time. Some manufacturers promise their water meter batteries would survive up to 16 years, but that is a highly optimistic view—especially if the transmission interval is more than once in a day, the battery life may be easily shorter than promised, even to as low as 5 years.

The need for batteries would be eliminated if the water meter could generate the necessary power by itself.

Water metering can be achieved through either mechanical, or IoT (smart) water meters. The issue with the former is that manual reading of the meter is required, for example by sending a technician to record a reading (very time consuming, expensive to pay many technicians to constantly travel to record people's meter readings), or by requesting the water company customer to record a reading themselves—thus relying on trust.

The issue with the latter is the need for batteries, or an external power connection. The issue with batteries is that they shorten the life of meters below that of mechanical meters (mechanical meters are expected to last on average 20 years).

Battery powered smart meter manufacturers usually claim up to 16 years of battery life, however this is rather optimistic. Moreover, frequent transmission (more than once a day) may drastically reduce the meter's battery life—sometimes even down to 5 years. Moving on, the issue with externally powered meters is quite obvious—not all locations feature the ability to provide power, especially when the meter is located outside, in publicly accessible locations, or in old buildings. If a place does not feature an electrical connection, and an externally powered meter is to be installed, electrical wires must be run to the location, which may be costly, will require renovation and an electrician to do the job—thus inconveniencing the customer and costing the water company.

### PRIOR ART DESCRIPTION

The reading process has also been modernized in the prior art to an extent where the technician reads the water meter with a portable electronic device and takes the water meter readings with him in the portable device. This avoids the need to use pen and paper. European patent EP 2314997 B1 discloses a method where leaks in pipes are detected with pressure and vibration. International patent application WO 2020215116 A1 discloses detecting fluid flow signals in a water pipe network, which fluid flow signals can be used to detect present and future leakage sites in the pipes.

United States patent application US20150135852 A1 discloses a battery free meter for flowing media, for measuring fluid flow. The kinetic energy of the fluid motion, i.e. flow, powers this meter.

A system for a self-powered energy generation is described in U.S. Pat. No. 11,988,538 B2, utilizing pressure changes within the water pipeline network to generate electricity locally.

The patent expects there to be a pressure change of 0.5 bars daily. In this system, a piston or membrane responds to dynamic pressure variations, storing potential energy in a mechanical spring. The stored mechanical energy is then converted into electrical power with an electromagnetic generator.

The system is designed to function without batteries by aligning the energy generation and data transmission events with naturally occurring or deliberately introduced pressure pulses in the pipeline. The device may include mechanical or digital memory for storing consumption readings, and communication can occur via NB-IoT, LTE-M, Wireless M-Bus, LoRaWAN, or other low-power wireless networks.

The system enables the use of LPWAN protocols, such as NB-IoT and LTE-M, which leverage existing cellular network infrastructure. These protocols are generally more energy-intensive compared to those that require deployment of a dedicated local network, such as LoRaWAN. However, they offer a significant advantage in terms of scalability and ease of deployment, as there is no need for the utility provider to build and maintain its own communication network. As a result, the system can offer extended operational lifetime and reduced maintenance costs compared to traditional battery-powered smart meters.

Further embodiments described in the prior art include configurations with adjustable spring preload, membrane-based pistons, multi-level trigger mechanisms for different pressure thresholds, compact integration into existing plumbing infrastructure (e.g., cut-off valve assemblies) and NFC interface for the meter configuration and reporting purposes.

Applicant is unaware, and has not found any prior art in searches, of prior art related to the use of Bourdon tubes or metal bellows in water meters.

U.S. Pat. No. 11,988,538 B2 is believed to be the closest prior art. The prior art is limited in dynamic range, i.e. the prior art water meter cannot operate over a broad range of pressure conditions. Especially very small pressure changes are difficult for the prior art to utilise.

Prior art smart water IoT sensors are battery operated, as shown in “AVK Smart Water solutions—The AVK Smart Water concept consists of battery-operated wireless IoT sensors for data collection directly from the network.”—A product brochure from AVK International A/S, April 2026. This document is cited here as reference.

### SUMMARY

It is the objective of the invention to provide a system accumulating mechanical energy in a spring, from multiple pressure variations, occurring over time in the plumbing system. This energy is then released when it reaches a predetermined threshold and converted to electrical energy through the use of an electromagnetic generator.

It is the objective of the invention to provide an integrated, energy-storing ratchet system with counting release mechanism.

It is further the objective of the invention to provide a solution where even smaller pressure changes could be harvested in addition to daily baseline changes.

It is further the objective of the invention to provide a mechanism which harvests smaller pressure changes in addition to daily baseline changes.

It is an embodiment of the invention to contain a mechanism which consists of an axial-rotation transformer, a transformer to store mechanical energy and a transmission system to transmit rotational energy.

It is an embodiment of the invention to contain a mechanism which is a Geneva mechanism transforming rotational movement into axial displacement, a spring storing and releasing mechanical rotation energy and a set of toothed gears transmitting rotational energy.

It is an embodiment of the invention to contain set of toothed gears connected together and forming a gearing.

It is an embodiment of the invention to contain a mechanism storing the energy over the course of multiple pressure changes in an energy storage device, spiral spring for example, which is held back from unwinding using a ratcheting mechanism.

The invention enables even harvesting of smaller pressure changes than 0.5 bar in addition to daily baseline changes. The Geneva mechanism allows for releasing the spring after specified rounds. For example, if the whole system is scaled down, there may be a need to wound the spring for more than one round.

The invention may replace mechanical meters without any modifications to the existing infrastructure. The meter is then able to power itself, and function automatically. Additionally, more frequent readings (which may be triggered by “sending” pressure spikes within the pipeline), won't shorten the meter's lifespan significantly—with a goal lifespan of minimum 15 years.

Moreover, the system according to the invention includes an NFC interface for configuration and reporting purposes. The NFC interface is activated via NFC phone and a mobile phone application. When activated, the electronics of the water meter are powered up, and encrypted communication channel is established between the mobile device and the meter. During the configuration process, parameters such as communication settings, meter identification number, encryption keys, and installation location can be written to the meter. Additionally, the mobile application forwards these configuration details to the water utility's database. The NFC interface could be also used to read the meter reading via mobile phone application after installation and configuration process.

The invention solves the problem of how to power an IoT (smart) water pipeline network component, including data transmission, without utilizing external sources of electricity (such as a wall plug), or batteries. In addition to being used as a water meter, a water pipeline network sensor, a sensor monitoring a valve, a pressure sensor, a temperature sensor, a measurement sensor measuring the chemical composition of the liquid in the water pipeline network, a sensor measuring fluid surface position and/or any other sensor in the water pipeline network can be powered using the invention.

A water pipeline network component in accordance with the invention is characterised in that,
a water pipeline network component is a self-powered water pipeline network component and does not use grid electricity or battery power to power its operation,
the self-powered water pipeline network component receives its operation power from pressure changes in the water pipeline network,
the self-powered water pipeline network component is configured to harvest the energy in the hydrostatic water pressure change in the water pipeline network with at least one energy harvester,
the mechanic movement of the energy harvester is configured to rotate a cogwheel, and the cogwheel is configured to increase tension in a mechanical spring, thereby storing potential energy,
a ratchet is configured to lock the cogwheel or the mechanical spring, and allow the energy harvester, to change position when the pressure decreases, without losing potential energy in the mechanical spring.

The said water pipeline network component is also characterised in that, multiple pressure increases in the water pipeline network are harvested, the ratchet stopping the cogwheel when water pipeline pressure decreases, but allowing the cogwheel to move and tighten the mechanical spring to store more potential energy, when water pipeline pressure is increased.

A self-powered IoT water pipeline network component in accordance with the invention is characterised by being powered by energy gathered from pressure changes in the water pipeline to which it is mounted on, and the water meter comprises a piston or a bellow responding to the pressure changes in the pipeline and is characterised in that, the water pipeline network component comprises an energy storage mechanism configured to store energy over the course of multiple pressure changes in the pipeline to an energy storage device, and the energy storage device is optionally a spiral spring, which is held back from unwinding by a ratcheting mechanism.

In addition, and with reference to the aforementioned advantage accruing embodiments, the best mode of the invention is considered to be a water sensor powered by an energy harvester that is a piston-spring rolling diaphragm actuator or a metal bellow actuator immersed into the water of the water pipeline network and an integrated energy-storing ratchet system with counting release mechanism. The best mode is especially preferably because the piston-spring rolling diaphragm actuator and the metal bellow actuator have dynamic ranges that can harvest pressure changes that are both big and small. This dynamic range is important, because typically a water pipeline network will have many pressure fluctuations of a small pressure change and few pressure fluctuations with a large pressure change.

Stated differently, a piston-spring rolling diaphragm actuator or a metal bellow actuator can be selected so that it has a good “response function” to the pressure changes in the water pipeline network. Combining this energy harvester with the integrated energy storing ratchet system is especially preferable, because most pressure fluctuations, being small, are insufficient to power the reading of the water sensor. However, when the inventive ratchet system is combined with the piston-spring rolling diaphragm actuator or a metal bellow actuator, the ability to detect many pressure fluctuations, most of them small, and harvest the energy in all these fluctuations as potential energy into a ratchet: the result is that also smaller fractional portions of water meter operation energy are harvested, which portions added together by the ratchet, make it possible to power the water sensor.

The water sensor is thus sufficiently powered to keep track of water consumption or quality in the best mode, and communicate the measurements to the water department. The best mode use is a water sensor that is immersed into a very difficult and unreachable position in the water pipeline network, at which unreachable position, changing a battery would be tedious and time consuming. These positions could be very deep underground, midway in a very long pipe and so on.

### BRIEF DESCRIPTION OF THE DRAWINGS

In the following the invention will be described in greater detail with reference to exemplary embodiments in accordance with the accompanying drawings, in which

FIG. 1 presents an embodiment 10 of the ratchet system mechanism for the water meter according to the invention.

FIG. 2 presents the same mechanism as in FIG. 1 but from different viewpoint 20 in accordance with the invention.

FIG. 3 presents the same mechanism as in FIGS. 1 and 2 but from different viewpoint 30 in accordance with the invention.

FIG. 4 presents the same mechanism as in FIGS. 1, 2 and 3 but from different viewpoint 40 in accordance with the invention.

FIG. 5 presents an embodiment 50 of the mechanism, e.g. Geneva wheel, for the water meter, according to the invention.

FIG. 6 demonstrates an embodiment 60 of the inventive water meter powering mechanism using a Bourdon tube.

FIG. 7 demonstrates the embodiment 70 of the inventive water meter powering mechanism using a piston-spring-rolling diaphragm actuator.

FIG. 8 demonstrates an embodiment 80 of the inventive water meter powering mechanism using a metal bellow actuator.

FIG. 9 demonstrates an embodiment 90 of the cogwheel gearing of the ratchet of the invention.

FIG. 10 demonstrates an embodiment 91 of the electromagnetic generator of the invention.

FIGS. 11A, 11B, 11C, 11D illustrate the inventive water meter powering mechanism using a ratcheting mechanism.

FIG. 12 illustrates an embodiment 95 of the inventive water metering method as a flow diagram.

FIG. 13 illustrates a water meter with the powering mechanism inside in embodiment 96.

FIG. 14 illustrates a water meter with the powering mechanism inside revealed in embodiment 97.

FIG. 15 illustrates an embodiment 98 where an energy harvester of the invention is used to power a water pipeline network component.

Some of the embodiments are described in the dependent claims.

### DETAILED DESCRIPTION OF EMBODIMENTS

The figures below explain the invention being used to power a water meter. However, any other water pipeline network device or sensor can be powered with the invention.

Any water pipeline network device or sensor can be powered with piston-spring actuator 70, metal bellow 80 or Bourdon tube actuator 60 of the invention, which are explained in the following. For example, the water pipeline network component can be a water meter, a water pipeline network sensor, a sensor monitoring a valve, a pressure sensor, a temperature sensor, a measurement sensor measuring the chemical composition of the liquid in the water pipeline network, a sensor measuring fluid surface position and/or any other sensor in the water pipeline network.

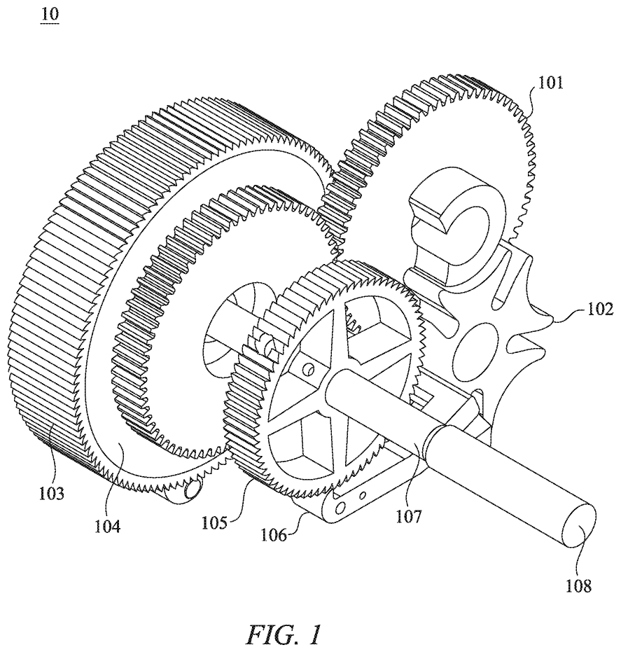

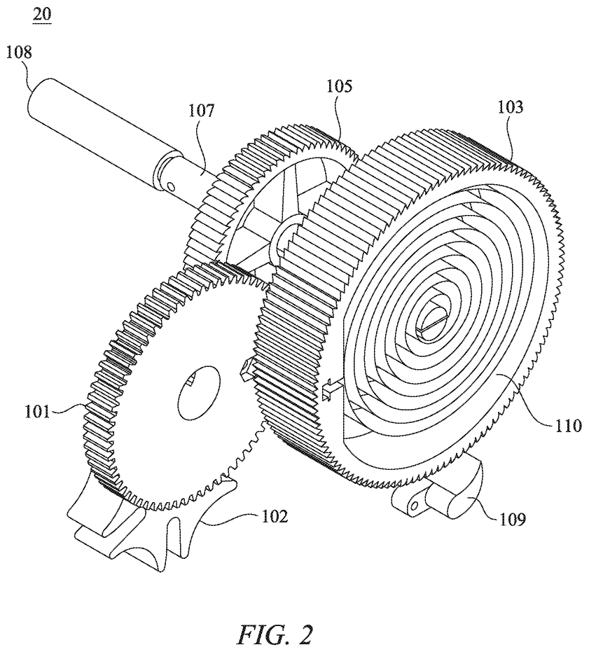

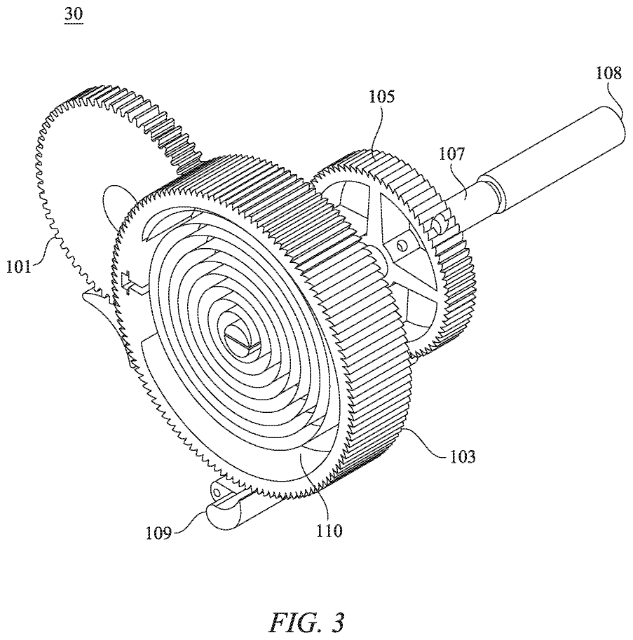

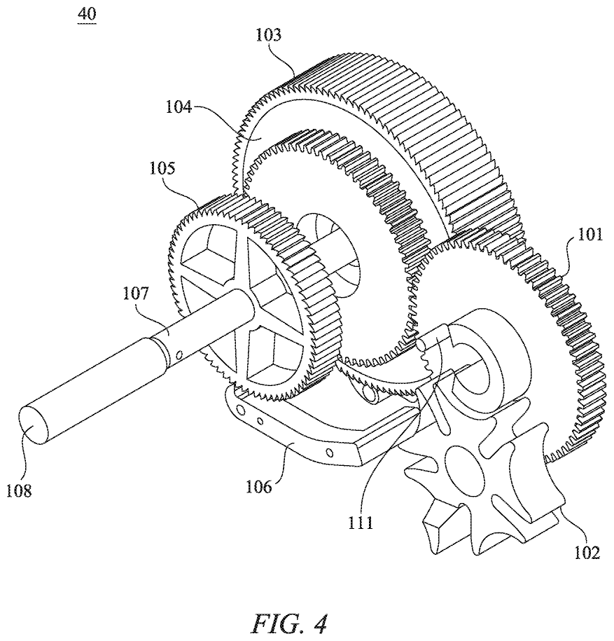

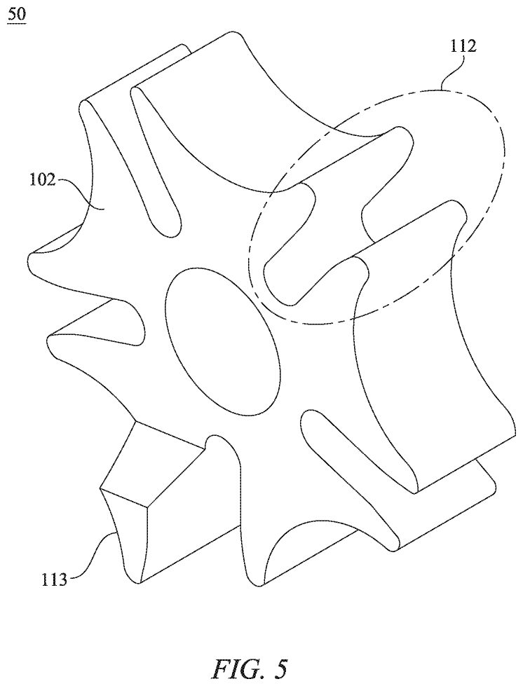

FIGS. 1-5 disclose a mechanism 10 designed to operate within a self-powered IoT (smart) water meter, powering it solely from energy gathered from pressure changes in the pipeline which it is mounted on. As the pressure variance is usually rather small (on average±0.5 bar per day), the mechanism 10 is designed to capture and harvest even the smallest changes—which are constantly happening (for example±0.1 bar). Thus—the mechanism 10 stores the energy over the course of multiple pressure changes in an energy storage device, spiral spring for example, which is held back from unwinding using a ratcheting mechanism.

Once a pre-determined amount of potential energy is stored in the spiral spring, the energy is released as rotational energy which spins a geared electro-magnetic generator that generates electrical energy, that powers the reading of the water meter, updates its e-ink display, as well as the transmission of the afore-mentioned value to the water company, as well as their customers.

The pre-determined amount of potential energy which is stored in the spring before it is released is determined by a transmission mechanism, for example a Geneva mechanism (also known as a Maltese cross mechanism), which counts the number of rotations of the main ratchet gear, and thus the amount of energy stored in the spring. The mechanism 10 can be adjusted, to release after a certain number of rotations of the main ratchet gear—for example 101, 102, 104, etc. (with more precise gearing), which determines how much energy will be released into the electro-magnetic generator, and thus how much electricity will be generated.

If the water company wishes to transmit at a higher frequency (smaller time intervals), they would be able to generate (send) additional pressure pulses, or spikes, which would allow the mechanism to harvest, and accumulate more energy, thus increasing the amount of energy produced and allowing for transmissions more often. The mechanism was designed to operate with the pressure changes present in pipes currently but could benefit from higher variance in pressure.

A membrane piston (not seen in the picture) reacts to pressure fluctuations in the pipeline. The linear movement from piston rotates the main ratchet gear (103) on the shaft (107) in steps when the piston is extending. The main spring (110), which is connected to the main ratchet gear (103) and the main shaft (107), gets tensioned when the main ratchet gear (103) rotates. The increase of spring (110) tension is possible because the main shaft (107) is blocked from rotating by retaining ratchet gear (105), which is fixed to the main shaft (107). The rotation of retaining ratchet gear (105) is blocked by release mechanism retaining pawl (106). Only outer end of the spring (110) can move along the main ratchet gear (103). Accumulation of energy to the spring (110) through several piston strokes is possible because main gear retaining pawl (109) is preventing reverse rotation of the main ratchet gear (103) between membrane piston strokes. The Geneva mechanism synchro gear (104) is integrated to the main ratchet gear (103) and that's why it rotates in the same phase as the main ratchet gear (103). Geneva mechanism synchro gear (104) rotates the Geneva drive gear (101) which drives Geneva wheel (102) by pin (111) on its surface. Geneva wheel (102) rotates

$$\frac{360 °}{amount of arms ( 2.1 )}$$

while the Geneva drive gear (101) completes one round. The Geneva wheel (102) in these figures has five arms (112) so it rotates

$$\frac{360 °}{5} = 72 °$$

in one cycle. Optionally, the Geneva wheel (102) may have arbitrary number of arms and slots. The amount and placement of elevated sections (113) on the Geneva wheel (102) define the operation time of release mechanism retaining pawl (106). When an elevated section (113) pushes on release mechanism retaining pawl (106), it lets go of the retaining ratchet gear (105). This is followed by release of spring (110) energy into the main shaft (107). The geared electro-magnetic generator (108) axle is attached to the main shaft (107), and it spins at the same time as the main shaft (107), generating energy to be used in functions of the water meter.

### Nomenclature

1. Geneva drive gear
   a. Rotates in conjunction with the Geneva mechanism synchro gear (104) and thus also the main ratchet gear (103).
   i. Relative rotational speed can be defined by sizes of Geneva drive gear (101) and Geneva mechanism synchro gear (104) enabling precise determination of the relative number of rotations (e.g. 1, 3 rotations).
   b. Drives the Geneva wheel (102) through the Pin (111) located on its surface
2. Geneva wheel
   a. Acts as a mechanical counter for the number or rotations of the Geneva drive gear (101), and thus how much potential energy is stored in the mainspring (101).
   b. Driven by the Pin (111) located on the Geneva drive gear (101). Only rotates the distance from one arm (112) to another with every rotation of the Geneva drive gear (101).
   c. Contains an elevated section (113) on one or multiples arms (112) of the wheel, which triggers the release mechanism retaining pawl (101) to be triggered. The number of elevated sections (113) determines how often (after how many rotations of the Geneva drive gear (101)) the potential energy stored in the mainspring (110) is released
   i. The maximum number of elevated sections (113) is equal to number of arms (112)
3. Main ratchet gear
   a. The main ratchet gear (101) houses the mainspring (110), which is connected to it on the inside wall.
   b. The outer surface consists of minimal size ratchet teeth, in order to maximize the amount of energy captured by even the smallest movements of the piston.
   c. The gear is advanced by the piston, which itself is driven by pressure changes.
4. Geneva mechanism synchro gear
   a. Rigidly attached to the main ratchet gear (103).
   b. Synchronizes the Geneva drive gear (101) with the rotation of the main ratchet gear (103).
5. Retaining ratchet gear
   a. Rigidly attached to the main shaft (107) and prevents it from rotating when locked in by the release mechanism retaining pawl (106)
   b. This allows for the mainspring (110) to accumulate potential energy
6. Release mechanism retaining pawl
   a. Physically prevents the ratchet retaining gear (105) from spinning, which in turn prevents the main shaft (107) from rotating.
   b. When pushed up by the elevated section (113) of the Geneva wheel (102), the pawl pivots around the axis located directly under the ratchet retaining gear (105), thus disengaging the pawl (106) and allowing the ratchet retaining gear (105), main shaft (107), and geared electro-magnetic generator (108) to rotate.
7. Main shaft
   a. The main shaft (107) directly and rigidly connects the mainspring (110), the retaining ratchet gear (105) and the geared electro-magnetic generator (108).
   b. After the mainspring (110) has accumulated a predetermined amount of potential energy, the axle is released to spin by the elevated section (113) of the Geneva wheel (102). The geared electro-magnetic generator (108) is then spun and generates electrical energy.
8. Geared electro-magnetic generator
   a. Rigidly coupled to the main shaft (107)
   b. Has a built-in gearbox, which allows for the generator to be spun at an optimal speed.
   c. Generates electrical energy when the main shaft (107) is spun
9. Main gear retaining pawl
   a. Prevents the main ratchet gear (101) from rotating backwards as the mainspring (110) is being wound up, and the piston is returning to its nominal position.
   b. The pawl (106) locks the main ratchet gear (101) in place after it is advanced by one ratchet tooth.
10. Mainspring (spiral torsion spring)
   a. The mainspring (110) accumulates rotational energy received through the main ratchet gear (103), which is being driven by the piston.
   b. Alternatively, another type of spring such as a constant force spring could be used.
Membrane piston (not present in the diagram)
   a. The piston is a component that converts pressure change into a linear movement. Ideally, it should have minimal friction, so that the energy harvested from small pressure changes does not get lost to parasitic forces. The end of the piston is advancing the main ratchet gear (103).

Any features of embodiments 10, 20, 30, 40, 50 may be readily combined or permuted with any of the other embodiments 60, 70, 80, 90, 91, 92, 93, 94, 95, 96, 97 and/or 98 in accordance with the invention.

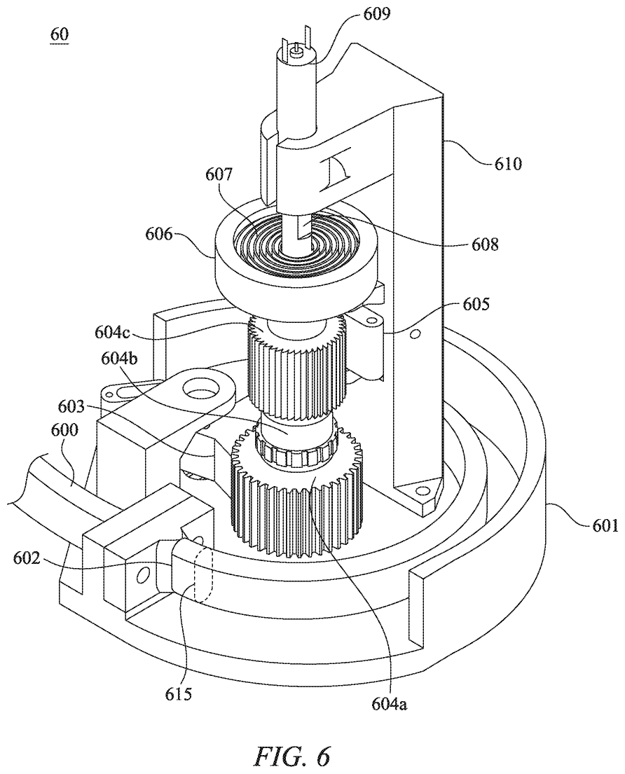

FIGS. 6-11A-D disclose a mechanism designed to operate within a self-powered IoT water pipeline network component, powering it solely from energy gathered from pressure changes in the pipeline which it is mounted on.

FIG. 6 discloses an embodiment 60 with Bourdon tube 602 that accepts water from the water pipeline network 600 into itself, and has an oval perimeter shown as 615. The base pressure variation during a day is usually rather small (on average 0.5 bar per day), the mechanism is designed to harvest energy from even smaller pressure variations (for example±0.1 bar) that happen more frequently in a pipeline. Thus—the mechanism stores the energy gathered over the course of multiple pressure changes in a spiral spring, that is held back from unwinding using a ratcheting mechanism, 604a, 604b, 604c.

Once a pre-determined amount of potential energy gathered from the movement of a Bourdon tube 602 is stored in the spiral spring 607, it is subsequently released as rotational energy which spins a geared electro-magnetic generator 609 that generates electrical energy. This powers the consumption reading of the water meter, and updates an externally mounted low-power display, as well as providing the necessary power for a transmission of the aforementioned value to, for example, a water company's server, as well as their customer-facing software & services. Transmission of data can take place for example via NB-IoT, LTE-M, Wireless M-Bus, LoRaWAN, or other low-power wireless networks in some embodiments.

The mechanism can be adjusted, to release after a certain number of rotations of the main ratchet gear 604a, 604b, 604c—for example 1,2,4 rotations etc. This also allows for sub-rotation precision through differential gearing, which pre-determines how much potential rotational energy will be released into the electro-magnetic generator, and thus how much electricity will be generated in accordance with the invention.

If for example water company wishes the water pipeline network component to transmit at a higher frequency (smaller time intervals), the water company or—department would have the ability to generate additional pressure pulses in the water network, which would allow the mechanism 60, 70 and/or 80 to harvest and accumulate more energy, thus increasing the amount of electricity produced and allowing for more frequent water sensor reading data transmissions. Although, it is important to note that the mechanisms 60, 70, 80 were designed to operate with the pressure changes already present in the pipeline, these could also benefit from higher variance in water pressure in some embodiments of the invention.

The mechanisms in FIGS. 6, 7, 8 use pressure fluctuations to harvest energy in order to power water pipeline network components, such as a water meter for water consumption recording. The energy obtained can be used for example for updating a low-power display and/or sending water consumption readings wirelessly to the water department or water company. Preferably the mechanism 60, 70, 80 fits inside water pipeline network component, for example a water meter.

When the pressure fluctuates in a pipeline (600), the Bourdon tube (602) reacts to it by moving. The movement drives the attached helical gear arm (603) causing the helical gear (604a) rotation back and forth. A ratchet (604b), that is rigidly connected to the helical gear (604a), causes the whole system to rotate anticlockwise when pressure increases, except for the shaft (608), which is locked by a rotation-count-controlled release mechanism.

The retaining pawl (605) allows the ratchet gear (604c) to rotate in only one direction and keeps the whole system still when the helical gear (604a) is moving clockwise when pressure decreases.

When the whole system is rotated expect for shaft (608) anticlockwise, the spiral spring (607) is tensioned, capturing potential energy in it. Tensioning is possible because the spiral spring (607) is attached to the spiral spring housing (606) on its outermost part, and to the shaft that remains still, from the middle.

The rotation-count-controlled release mechanism releases the shaft (608) when the ratchet gear (604c) has achieved a predetermined number of rotations that drives the release mechanism. When shaft (608) is released, it causes the rotation of the geared electro-magnetic generator (609) that provides electric power for the water meter to read the water consumption, optionally updating the low-power display, and to sending the water consumption data wirelessly.

Post the data transmission, the rotation of the ratchet gear (604c) drives the rotation-count-controlled release mechanism to lock again the shaft (608), and the process can again start over, eventually leading to the reading and the transmission of the water consumption data at a later time.

It is also possible to tension the spiral spring (607) by manually winding it from the outside of the meter housing, and thereby to manually power the meter.

Below is a list of components needed to realise the inventive technology with a Bourdon tube discussed in FIGS. 6, 9, 10, 12, 13, 14:
1. base (Water meter housing)
   a) Bourdon tube (602), helical gear lever arm (603), ratchet assembly (604) and support arm (610) are connected to the base (601)
   b) The base (601) has a raised area behind the Bourdon tube (602) to protect it from overbending. This area is designed according to the maximum pressure the Bourdon tube (602) can withstand.
2. Bourdon tube
   a) Moves caused by pressure fluctuation in the pipeline (600) that is connected.
   b) Moves the helical gear lever arm (603)
3. helical gear lever arm
   a) Has a pivot on the base (601)
   b) Is attached to the Bourdon tube (602)
   c) Turns the helical gear (604a)
4. ratchet assembly
   4.1 helical gear
   a) Rotates back and forth because of movement of the helical gear lever arm (603)
   b) Can rotate back and forth
   c) Is rigidly connected to ratchet (604b)
4.2 ratchet
   a) Rotates back and forth caused by helical gear (604a) movement
   b) is rigidly connected to ratchet gear (604c)
   c) Rotates the whole system above to one direction
   d) When moving backwards the retaining pawl (605) keeps the whole system above still
4.3 ratchet gear
   a) is rigidly connected to the ratchet (604b) and spiral spring housing (606)
   b) Rotates only one direction caused by the ratchet (604b)
   c) Is stopped by retaining pawl (605)
5. retaining pawl
   a) is connected to support arm (610)
   b) Allows the ratchet gear (604c) to rotate in one direction
6. spiral spring housing
   a) Is rigidly connected to the ratchet gear (604c)
   b) Rotates only one direction together with the ratchet gear (604c)
   c) Outer head of the spiral spring (607) is connected to its body
   d) Has bearing (611) on the middle for shaft (608)
7. spiral spring
   a) Is connected to spiral spring housing (606) by its outermost part
   b) Is attached at its middle section to the shaft (608)
   c) Is tensioned when helical gear (604a) rotates in the right direction which is caused by ratchet (604b) and the rotation-count-controlled release mechanism is keeping the shaft (608) still.
8. shaft
   a) Is connected to the bearing (611) that is located at the bottom of the spiral spring housing (606)
   b) Is connected to the spiral spring (607)
   c) Is attached to the geared electro-magnetic generator (609).
   d) The rotation-count-controlled release mechanism (not shown) is locking and releasing the shaft (608) from this point. Pliers are currently serving as the rotation count controlled mechanism in the manual implementation.
   e) The shaft (608) is rotated by potential energy of tensioned spiral spring (607). It can spin freely from the other system because of connection to the bearing (611) on the bottom of the spiral spring housing (606)
   f) When spiral spring (607) is tensioned and the rotation-count-controlled release mechanism is released, shaft (608) rotates seared electro-magnetic generator (609) providing electrical power to the water meter.
9. geared electro-magnetic generator
   a) Is rigidly attached to the shaft (608) from its rod
   b) Is rigidly connected to the support arm (610)
   c) Provide electrical power when shaft (608) spins
10. support arm
   a) Is connected to the base (601)
   b) Gives mounting places for the retaining pawl (605) and the geared electro-magnetic generator (609)
11. Bearing
   a) Is located at the bottom of spiral spring housing (606)
   b) Enables the shaft (608) to rotate freely from the other system.

The Bourdon tube interfaces quite nicely with the water in the pipeline itself, but produces very low or insufficient amounts of energy. It could be a choice for very low energy budget embodiments.

Any features of embodiment 60 may be readily combined or permuted with any of the other embodiments 10, 20, 30, 40, 50, 70, 80, 90, 91, 92, 93, 94, 95, 96, 97 and/or 98 in accordance with the invention.

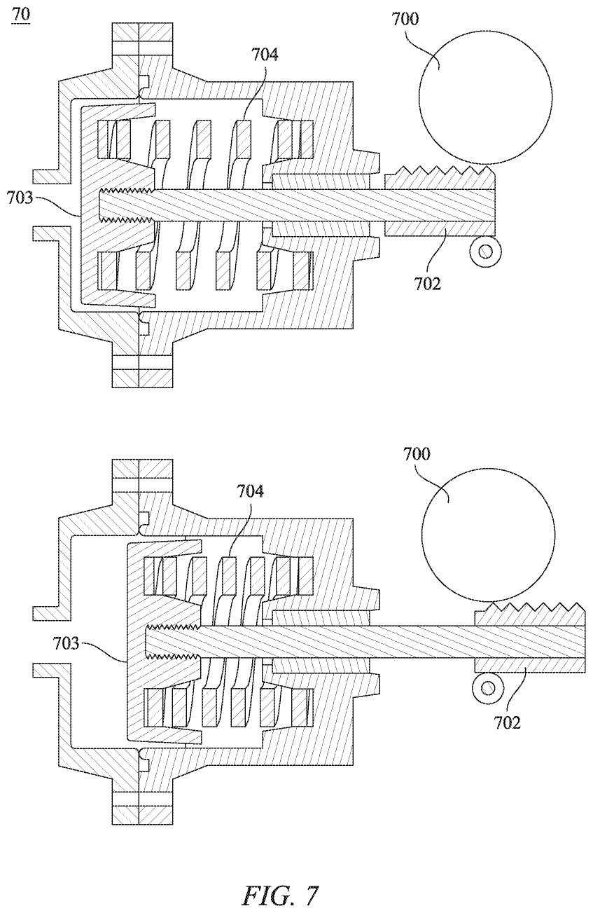

FIG. 7 shows an embodiment 70 with an improved energy/power budget, namely a piston-spring-rolling diaphragm actuator as the energy harvester. This actuator can produce considerably more energy than a Bourdon tube. The figure shows a longitudinal cross-section of the actuator. In the top of page figure, the water pipeline pressure is low. The spring 704 with the indentation 702 is in the extended state.

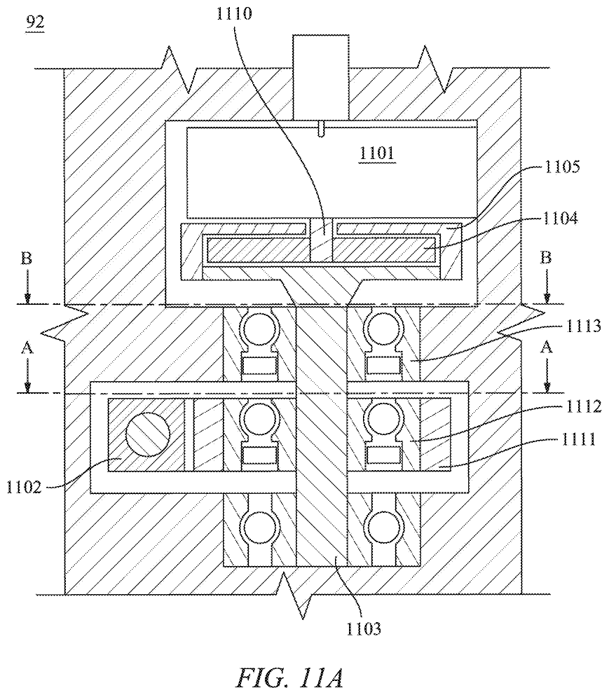

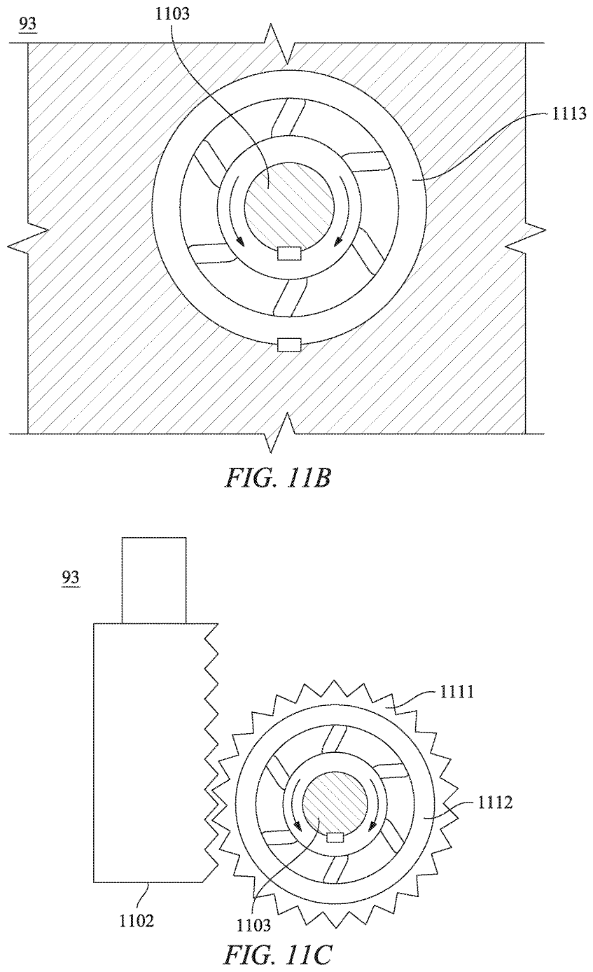

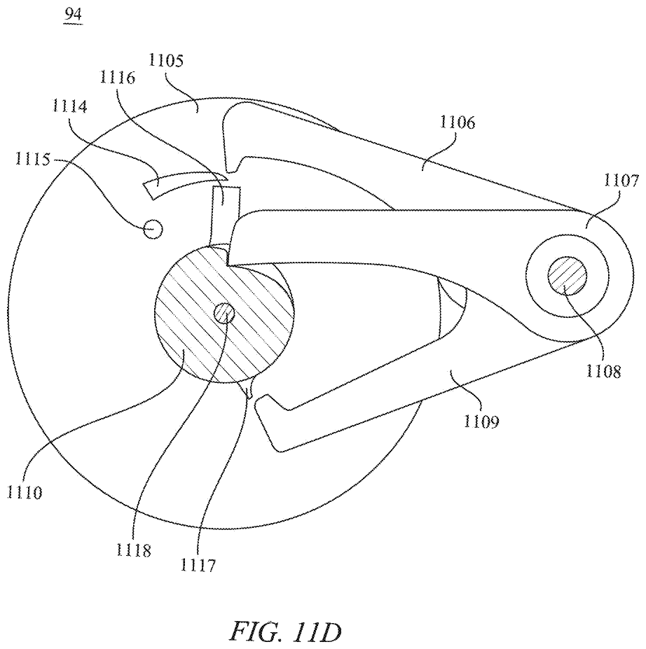

As the pressure increases as shown in the bottom of the page figure, the piston 703 is pushed and the spring 704 compresses, pushing the indentation 702 past the gearwheel 700, 1111 that is connected to a shaft 1103 with a one-way clutch 1112, see also FIG. 11C. One-way clutch 1112 is transferring this movement of indentation 702 downward on page to anticlockwise rotational movement of shaft 1103 when the pressure increases.

The anticlockwise rotational movement of shaft 1103 is tightening the tension for spiral spring 1104, as it is connected from the outer circle to spring case 1105 that is rigidly connected to shaft 1103. The spiral spring 607, 1104 is kept still from the inner bore by release shaft 1110 that is kept in place with the locking arm 1107.

When the pressure again lowers, the spring 704 relaxes, and the indentation head 702 moves to the opposite direction, the gearwheel 1111 rotates clockwise freely, as the one-way clutch 1112 is not transferring the rotational movement into the shaft 1103.

The unwinding of spiral spring 1104 from the outer circle is prevented by one-way clutch 1113 that is kept in place from outer rim allowing shaft 1103 to rotate only anticlockwise and preventing it from rotating clockwise.

Any features of embodiment 70 may be readily combined or permuted with any of the other embodiments 10, 20, 30, 40, 50, 60, 80, 90, 91, 92, 93, 94, 95, 96, 97 and/or 98 in accordance with the invention.

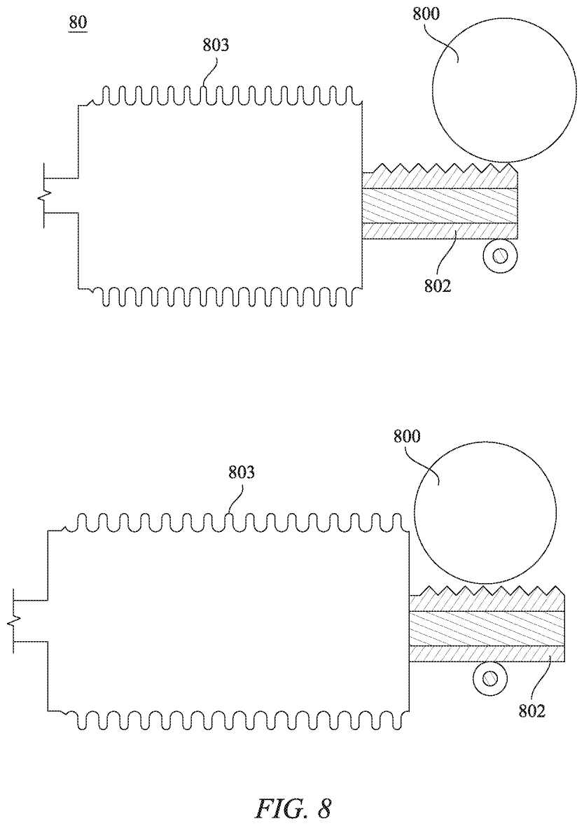

FIG. 8 shows another embodiment 80 that is a more efficient energy harvester than a Bourdon tube, namely a metal bellow actuator. In the top of page figure the pressure is low and the metal bellow 803 is smaller.

In the bottom of the page figure the water pipeline pressure has increased, and thus the metal bellow 803 has expanded, moving the indentation 802 to the right past the gearwheel 800, 1111. The gearwheel 800, 1111 tightens a spiral spring 1104, 607 with a similar working principle than described with the piston-spring-diaphragm mechanism above in FIG. 7, or the Bourdon tube in FIG. 6.

When the pressure again lowers, the metal bellow 803 relaxes to a smaller state as in the top of page figure, and the indentation 802 moves to the opposite direction. However, in this returning movement into the opposite direction the gearwheel 1111 does not engage the spiral spring 1104, 607.

Any features of embodiment 80 may be readily combined or permuted with any of the other embodiments 10, 20, 30, 40, 50, 60, 70, 90, 91, 92, 93, 94, 95, 96, 97 and/or 98 in accordance with the invention.

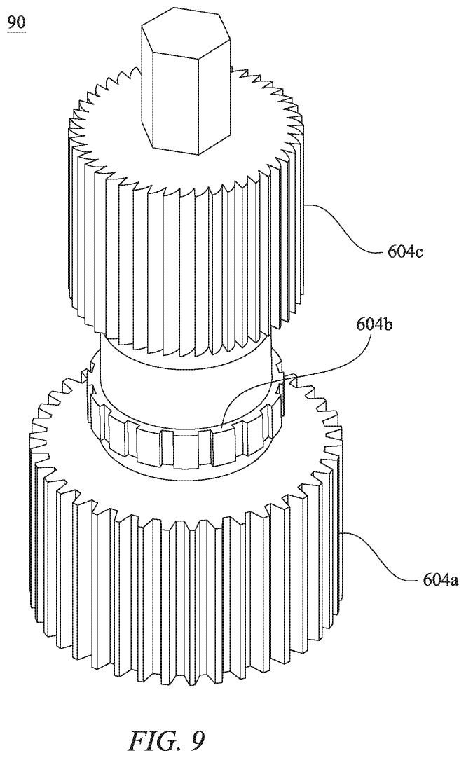

FIG. 9 demonstrates an embodiment 90 of the cogwheel gearing of the invention. The helical gear rotates back and forth because of movement of the helical gear lever arm (603), and the helical gear (604a) can rotate back and forth and is rigidly connected to ratchet (604b). The ratchet (604b) rotates back and forth caused by helical gear (604a) movement, but is rigidly connected to ratchet gear (604c). This gearing embodiment 90 could be applied with the metal bellow embodiment 80, or the piston-spring-rolling diaphragm actuator embodiment 70, or the Bourdon tube embodiment 60.

Any features of embodiment 90 may be readily combined or permuted with any of the other embodiments 10, 20, 30, 40, 50, 60, 70, 80, 91, 92, 93, 94, 95, 96, 97 and/or 98 in accordance with the invention.

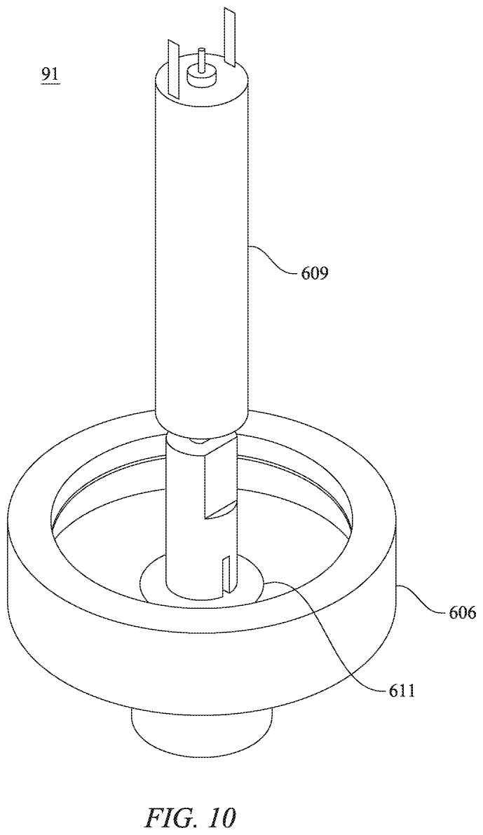

FIG. 10 demonstrates an embodiment 91 of the electromagnetic generator of the invention. Spiral spring housing (606) is shown here without the spiral spring (607). The shaft (608) is rotated by potential energy of tensioned spiral spring (607). It can spin freely from the other system because of connection to the bearing (611) on the bottom of the spiral spring housing (606).

When spiral spring (607) is tensioned and the rotation-count-controlled release mechanism is released, shaft (608) rotates geared electro-magnetic generator (609) providing electrical power to the water meter. This electromagnetic generator embodiment 91 could be applied with the metal bellow embodiment 80, or the piston-spring-rolling diaphragm actuator embodiment 70, or the Bourdon tube embodiment 60.

Any features of embodiment 91 may be readily combined or permuted with any of the other embodiments 10, 20, 30, 40, 50, 60, 70, 80, 90, 92, 93, 94, 95, 96, 97 and/or 98 in accordance with the invention.

FIGS. 11A, 11B, 11C and 11D show in a series of figures how inventive ratcheting works in preferable embodiments 92 and 93. This spiral spring tensioning 92, 93 and release embodiment 94, can be combined with any energy harvester: with the metal bellow embodiment 80, or the piston-spring-rolling diaphragm actuator embodiment 70, or the Bourdon tube embodiment 60.

FIG. 11B is a cut view B-B from FIG. 11A from the ratcheting mechanism from the embodiment 92. This cut view 93 shows the one-way clutch 1113 that prevents the spiral spring 1104 from unwinding, as it is kept still from the outer rim and that way allowing rotational movement to only one direction. When pressure increases, the middle shaft 1103 rotates anticlockwise tightening the spiral spring 1104. And when the pressure decreases, one-way clutch 1113 keeps the spiral spring 1104 tensioned by preventing shaft's 1103 clockwise rotation.

In FIG. 11C is a cut view A-A of FIG. 11A from the ratcheting mechanism from the embodiment 92. This cut view 93 shows the gear rack 1102 as well as gearwheel 1111 with built in one-way clutch to transfer only one-directional movement from the gear rack 1102 to the rotational movement of the shaft 1103. When pressure increases, gear rack 1102 moves down and rotates gearwheel 1111 and shaft 1103 anticlockwise, which is allowed by one-way clutch 1112.

When pressure decreases, the gear rack 1102 moves up rotating only gearwheel 1111 clockwise but keeping shaft 1103 in place, as one-way clutch 1112 prevents clockwise rotation of shaft 1103.

FIG. 11D shows an embodiment 94 of a release mechanism 1101. Release mechanism works by keeping the spiral spring 1104 tensioned until one full rotation has been winded. Spring case 1105 is rigidly connected to the shaft 1103 that is rotated with the pressure fluctuations, making the spring case 1105 to rotate clockwise tightening the spiral spring 1104. FIG. 11D shows the release mechanism just before it releases. Locking arm 1107 is keeping the locking shaft 1110 in place, and this locking shaft 1110 prevents spiral spring from unwinding by keeping it still from the inner bore.

When the spring case 1105 rotates clockwise, the releasing arm 1106 will get into contact with releasing slope 1114, that is rigidly connected to the spring case 1105, rotating the releasing arm 1106 clockwise. Releasing arm 1106 and locking arm 1107 are rigidly connected, so this movement will move the locking arm 1107 to open position, freeing locking shaft 1110 to rotate clockwise as the potential energy of the spiral spring 1104 gets released to rotational movement.

Geared electromagnetic generator's shaft 1118 is rigidly connected to shaft 1110, so this rotational movement of the locking shaft 1110 will spin geared electromagnetic generator's shaft 1118 generating electrical energy. When the locking shaft 1110 has rotated nearly one full rotation, the single release securing arm 1116 will contact the single release securing pin 1115 and use the remaining potential energy of the spiral spring 1104 to rotate spring case 1105 clockwise.

This will make sure that the releasing slope 1114 will move past the releasing arm 1106, making returning arm 1109 to move anticlockwise as it makes contact with returning pin 1117 securing the locking arm 1107 back to its initial position and locking the locking shaft 1110 in place.

Any features of embodiments 60, 70, 80, 90, 91, 92, 93, 94 may be readily combined or permuted with any of the other embodiments 10, 20, 30, 40, 50, 60, 95, 96, 97 and/or 98 in accordance with the invention.

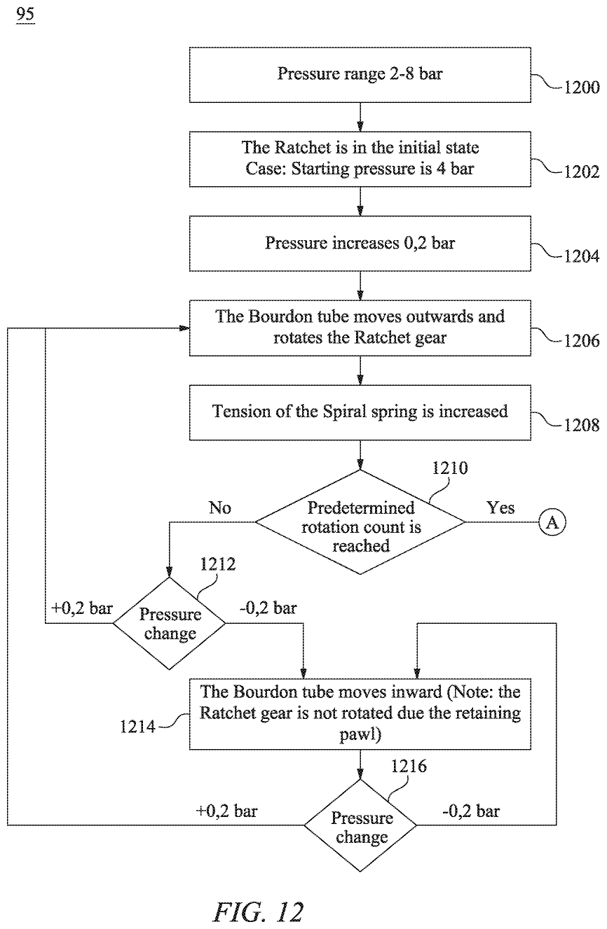

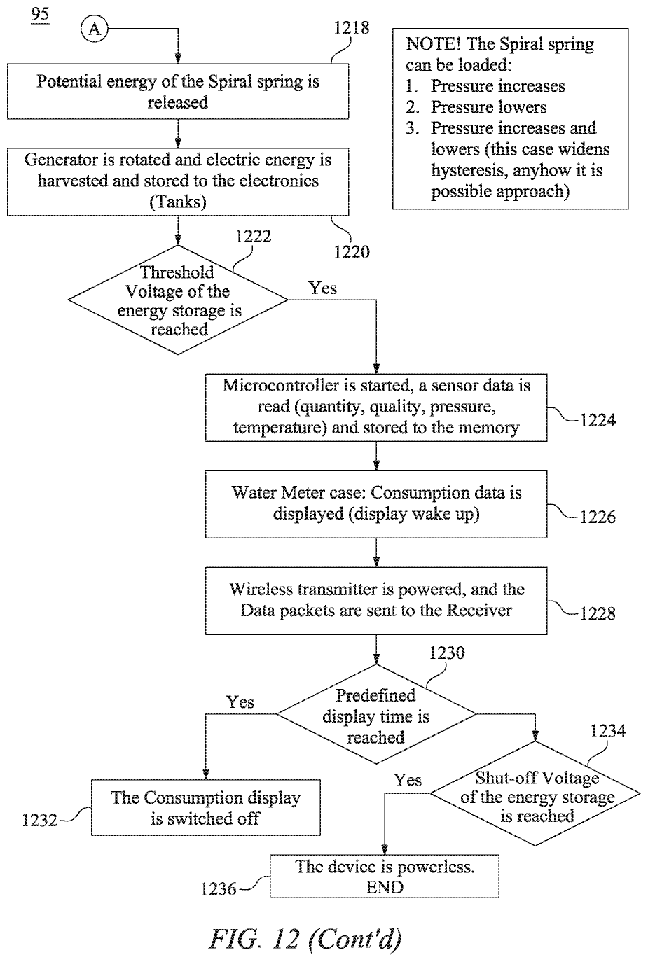

FIG. 12 discloses how the embodiment 95 of the invention operates as a flow diagram.

In phase 1200 water typically within the pressure range of 2-8 bar is flowing in the water pipeline network. In phase 1202 the ratchet is in the initial state, and the water that enters the Bourdon tube is at a pressure of 4 bar.

In phase 1204 water pressure increases by +0.2 bar. It is preferable to devise the mechanical response of the Bourdon tube 60, bellow 80 or piston 70 embodiment so that it has a mechanical response everywhere in the range of 2-8 bar. Additionally, within this range, the mechanical response to a 0.2 bar pressure change must leave a net kinetic energy sufficient to tighten the spiral spring after system losses such as friction, etc.

In phase 1206 the Bourdon tube moves outwards in response to the pressure increase, and rotates the ratchet gear 604. Alternatively, a bellow 80 or piston 70 embodiment could be configured to rotate ratchet gear 604.

In phase 1208 the tension in the spiral spring is increased. In phase 1210, a predetermined rotation count is elaborated, and if the rotation count has not been achieved yet, the system waits for a further pressure change in phase 1212. If the next pressure change is again an increase, of say again +0.2 bar, the system returns to phase 1206. If the water pressure drops, by say −0.2 bar, the system moves to phase 1214.

In phase 1214 the Bourdon tube moves inward, or the piston-spring or metal bellow embodiments 70, 80 relax. The ratchet gear is not rotated due to the retaining pawl in phase 1214. Next in phase 1216, if the next pressure change is sufficiently positive, say +0.2 bar, the system again moves to phase 1206. But if the next pressure change is a drop, for example −0.2 bar, the system returns to phase 1214.

If predetermined rotation count has been reached the inventive method moves to point A. From point A to phase 1218 in which potential energy of the spiral spring is released. In phase 1220 the generator is rotated, and electric energy is harvested 1220 and stored to the electronics, for example to a capacitor or a rechargeable battery, such as a rechargeable LTO battery.

In phase 1222 the threshold voltage of the energy storage is reached. In phase 1224 a microcontroller is started, and sensor data is read. This can include for example water quantity data, water quality data, water pressure data, water temperature data, and this date is stored into memory. In phase 1226 the water meter consumption data, or any data is displayed. However, the display on site is not mandatory in all embodiments of the invention. Some embodiments of the inventive water pipeline network component may be realised without a display.

In phase 1228 a wireless transmitter is powered, and the data packets are sent to a receiver, which is typically at the water department or water company or relays data to water department or water company. Transmission of data can take place for example via NB-IoT, LTE-M, Wireless M-Bus, LoRaWAN, or other low-power wireless networks in some embodiments.

In phase 1230 the predefined display time is reached, and the consumption display in the water pipeline network component is switched off in phase 1232. If the consumption is displayed, and there is display time remaining, phase 1234 is eventually commenced when the shut off voltage of the energy storage is reached, and in phase 1236 the device is without power, if the device does not have a rechargeable battery with residual energy. In those embodiment where the device has a rechargeable battery, there is some residual energy in that rechargeable battery and the device won't be completely without power in phase 1236.

Any features of embodiment 95 may be readily combined or permuted with any of the other embodiments 10, 20, 30, 40, 50, 60, 70, 80, 90, 91, 92, 93, 94, 96, 97 and/or 98 in accordance with the invention.

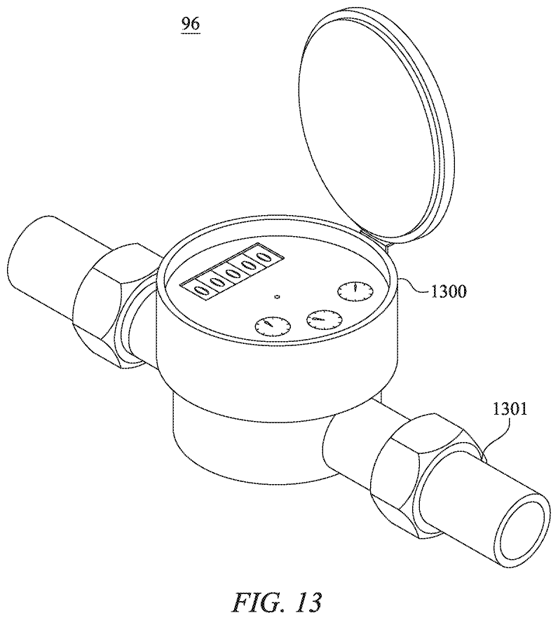

FIG. 13 discloses an embodiment 96 of a typical water meter with the inventive powering system hidden.

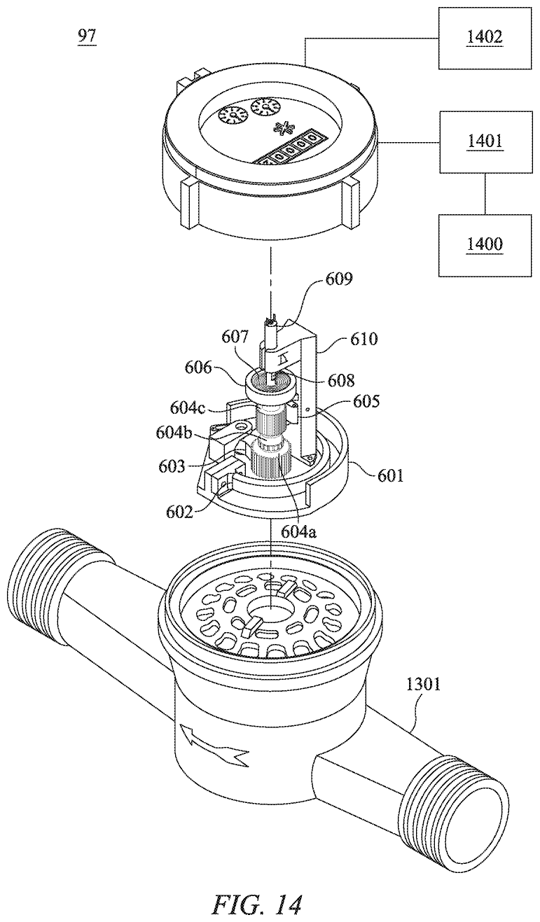

FIG. 14 discloses an embodiment 97 of a typical water meter revealing the inventive system revealed in proportion to the water meter and its surroundings. As shown, the powering mechanism 60, 70 80 is preferably about 10 cm of size, so that it is sufficiently small to fit inside a water meter 1300, or a typical water pipeline network component. However, the powering mechanism needs to be large enough to have sufficient inertial characteristics: The Bourdon tube embodiment 60, piston-spring embodiment 70, and/or metal bellow embodiment 80 need to be large enough to generate a motion that has excess kinetic energy after friction losses to store enough potential energy for the electronic circuits that e.g. read the water sensor reading and transmit it wirelessly or otherwise use the water pipeline network component. The same applies for the piston spring 70 and the metal bellow actuator 80.

In some preferable embodiments a water meter measures the water flow by ultrasound. The ultrasonic measurement is carried out both upstream and downstream, and the time of flight difference between the two ultrasound measurements is used to compute the velocity of water flow in the pipe. This velocity combined with the dimensions of the pipe is used to compute the volume of water consumed.

Any features of embodiments 96, 97 may be readily combined or permuted with any of the other embodiments 10, 20, 30, 40, 50, 60, 70, 80, 90, 91, 92, 93, 94, 95 and/or 98 in accordance with the invention.

The aforementioned embodiments may also be used in various sensors, for example in any of the following pipeline sensors: pressure sensor, flow sensor, temperature sensor, open/close sensor, level sensor, water quality sensor, fire hydrant cap sensor and/or valve position indicator.

Additionally, the aforementioned embodiments may also be used in various actuators, for example in any of the following pipeline actuators: pressure reducing valve, open/close valve and/or control valve.

Additionally, the aforementioned embodiments may also be used in an application where they are used both for powering the sensor and the actuator. One example is the motion sensor tap: the combination of a motion sensor and it actuating the tap.

Through accumulating mechanical energy in a spring, from multiple pressure variations, occurring over time in the plumbing system, kinetic energy is stored as potential energy. This energy is then released when it reaches a predetermined threshold and converted to electrical energy through the use of an electromagnetic generator.

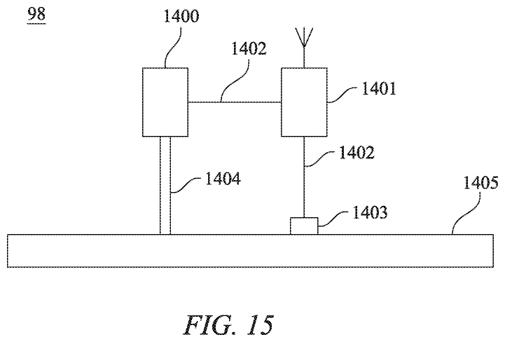

FIG. 15 shows an embodiment 98 where the energy harvester 1400 is realised as a separate power source 1400 to power a sensor 1403 that makes measurements from the water pipeline network 1405. A sensor reader and wireless transmitter 1401 is usually connected to the sensor 1403 via cable 1402, and the energy harvester 1400. The energy harvester 1400 receives the water pressure changes via the pipe 1404 that is connected to the water pipeline network 1405. Optionally the energy harvester 1400 might be used to charge a battery. In this optional case the energy harvester 1400 would comprise a battery charger.

A more complex gearing system could be developed that harvest kinetic energy from both motion directions of the Bourdon tube, piston spring, or metal bellow 60, 70, 80. This could be achieved for example with a system where the gear is switched from a negative pressure drop to a positive pressure increase, and vice versa, and two separate spiral springs are tensioned, the one with pressure drops and the other with pressure increases in accordance with the invention. The two separate spiral springs could be used to drive one electromagnetic generator, and the two springs could be released simultaneously, to co-produce power at the same time to power the water meter, in accordance with the invention. This would have an advantage in redundancy: If one component would fail, the other half would still work albeit inferiorly, and still allow the system to measure and communicate water attributes, albeit less frequently.

A more complex network communication system might involve a mesh network or a peer-to-peer network similar to Apple Find My. Also, the measurements could be communicated directly to the users mobile phone. In this embodiment, a mobile app could collect the data from the water meter using Bluetooth or NFC of the mobile phone.

The aforementioned embodiments assume 1-way communication from the water pipeline network component to the water Department, which usually uses a capacitor to store charge.

However, a more complex water measurement system involving 2-way communication will likely need an energy storage similar to supercapacitor or a battery, such as an LTO (Lithium-Titanate-Oxide) battery. A rechargeable battery such as LTO may be used in applications where a constant power supply is required to power a sensor or enable two-way communication.

In these embodiments, electrical energy harvested by the ratchet mechanism is stored in a capacitor or rechargeable battery to provide uninterrupted power to the device.

Typically, such rechargeable energy storage can provide power only for a short period of time, a few days or weeks in some embodiments. Therefore, the energy harvester is essential for long-term operation. This rechargeable energy storage thus has a much smaller capacity than the non-rechargeable battery of the prior art. The replacement of which non-rechargeable battery the invention aims to avoid.

In this 2-way embodiment the water department could also communicate to the water pipeline network component, for example a water meter. Typically, the water meters measure the water flow by ultrasound when an LTO battery is available, for example in the 2-way communication mode in accordance with the invention. When no LTO battery, or any battery, is available it is more sensible to use a mechanical flow meter instead of ultrasound. The energy harvesting solution 60, 70 or 80 is used to charge the battery.

The self-powered water meters of the invention bring about unexpected advantages to the water department. The municipal water department could be run based on the inventive water meter measurements. This includes opening of valves and rerouting water in the network to optimise the usage and water quality in the water pipeline network. In advanced embodiments an artificial intelligence model can be used to generate control instructions for operating the municipal water department network.

In one advanced embodiment of the invention, the AI model would be trained by showing network diagrams of real water pipeline network use. The network diagrams could be categorised as “high stress” and “low stress”, depicting the extent of wear and tear inflicted on the network in a particular network configuration. The AI model is then trained to distinguish between “high stress” and “low stress” network configuration. A computer is set up to produce the network diagram of the water pipeline network at regular intervals, and show it to the AI model, which classifies it as “high stress” or “low stress”. When a “high stress” configuration is detected, preprogrammed steps can be taken to restore the water pipeline network to “low stress” configuration, or the situation can be escalated to a human operator for decision making.

The invention has been explained above with reference to the aforementioned embodiments, and several commercial and industrial advantages have been demonstrated. The methods and arrangements of the invention allow to power an IoT (smart) flow meter, including data transmission, and digital consumption display, without utilising external sources of electricity (such as a wall plug), or batteries.

A water utilities company will benefit of the inventive water meter with advantages that can include the following:
Self-updating flow meter readings->no need to send out technicians to manually record meter readings,
More frequent meter reading recordings->ability to detect leaks in specific pipe networks by comparing volume of water sent, and received at endpoints within a specified timeframe,
Ability to monitor peak usage periods, and adapt the water supply & network pressure accordingly,
Ability to manage water more efficiently through the availability of more detailed, higher accuracy water usage data (as well as possible additional data types such as pressure/temperature data),
Potential for the implementation of a spot pricing model (for example, initially day-based price changes),
No need to replace batteries/whole meter after the batteries have run out,
No battery waste generated.

These advantages typically result in lower life cycle costs and longer life cycle for the inventive water meter.

End users of the inventive water meter enjoy advantages like any of the following:
Remote reading, leak alerts, data analysis in-app, water usage statistics and logging, etc.,
Potential for spot pricing to bring lower water costs.

Any water pipeline network device or sensor can be powered with piston-spring actuator 70, metal bellow 80 or Bourdon tube actuator 60 of the invention. For example, the water pipeline network component can be a water meter, a water pipeline network sensor, a sensor monitoring a valve, a pressure sensor, a temperature sensor, a measurement sensor measuring the chemical composition of the liquid in the water pipeline network, a sensor measuring fluid surface position and/or any other sensor in the water pipeline network. The water pipeline network can thus be made self-aware with the self-powered sensors of the invention, which opens up new possibilities for using and maintaining the water pipeline network.

The invention has been explained above with reference to the aforementioned embodiments. However, it is clear that the invention is not only restricted to these embodiments, but comprises all possible embodiments within the spirit and scope of the inventive thought and the following patent claims.

1. A water pipeline network component, characterised in that,
the water pipeline network component is a self-powered water pipeline network component and does not use grid electricity or battery power to power its operation,
the self-powered water pipeline network component receives its operation power from pressure changes in the water pipeline network,
the self-powered water pipeline network component is configured to harvest the energy in the hydrostatic water pressure change in the water pipeline network with at least one energy harvester,
the mechanic movement of the energy harvester is configured to rotate a cogwheel, and the cogwheel is configured to increase tension in a mechanical spring, thereby storing potential energy,
a ratchet is configured to lock the cogwheel or axis or the mechanical spring, and allow the energy harvester, to change position when the pressure decreases, without losing potential energy in the mechanical spring.

2. A water pipeline network component as claimed in claim 1, characterised in that, multiple pressure increases in the water pipeline network are harvested, the ratchet stopping the cogwheel or axis when water pipeline pressure decreases, but allowing the cogwheel or axis to move and tighten the mechanical spring to store more potential energy, when water pipeline pressure is increased.

3. A water pipeline network component as claimed in claim 1, characterised in that, the energy harvester is any of the following: piston-spring rolling diaphragm actuator, metal bellow actuator, or Bourdon tube.

4. A water pipeline network component as claimed in claim 3, characterised in that, the energy harvester is a Bourdon tube, and
the Bourdon tube is immersed in the water of the pipeline network, with water entering inside the Bourdon tube,
when the hydrostatic pressure in the water inside the Bourdon tube increases, the Bourdon tube moves.

5. A water pipeline network component as claimed in claim 1, characterised in that, the water meter is configured to increase the tension of the spring with pressure variations of about 0.1 bar.

6. A water pipeline network component as claimed in claim 1, characterised in that, the stored potential energy in the spring is released as rotational energy which is configured to spin a geared electro-magnetic generator that generates electrical energy.

7. A water pipeline network component as claimed in claim 4, characterised in that, the electro-magnetic generator is configured to power the reading of the water pipeline network component.

8. A water pipeline network component as claimed in claim 5, characterised in that, the electro-magnetic generator is configured to power the transmission of the reading to the water department.

9. A water pipeline network component as claimed in claim 4, characterised in that, a certain number of rotations of the main ratchet gear or spring is configured to be released, which determines how much potential energy will be released into the electro-magnetic generator.

10. A water pipeline network component as claimed in claim 1, characterised in that, the water department in control of the water pipeline network generates pressure pulses into the water pipeline network configured to power the water pipeline network component.

11. A water pipeline network component as claimed in claim 1, characterised in that, the water pipeline network component is a water meter and comprises a wireless transmitter configured to transmit the water meter reading to the water department using any of the following: LPWAN, LoRaWAN (Long Range Wireless Access Network), cellular network, NB-IoT, LTE-M, Wireless M-Bus.

12. A water pipeline network component as claimed in claim 1, characterised in that, the water pipeline network component is a water meter and the water meter reading can be produced on-site to a display, or via NFC to a user mobile phone on-site.

13. A water pipeline network component as claimed in claim 1, characterised in that, the water pipeline network component is a water meter and the spring is configured to be manually tightened on site, allowing for a tenant or a technician to power a water meter reading and read the reading from the water meter.

14. A water pipeline network component as claimed in claim 4, characterised in that, calcium contamination into the tube is eliminated by a diaphragm separator and clean water is inside the Bourdon tube.

15. A water pipeline network component as claimed in claim 1, characterised in that, the water pipeline network component is a water meter and the water meter provides two-way communication to and from the water department, has a battery, and uses ultrasound for water flow measurement.

16. A water pipeline network component as claimed in claim 1, characterised in that, the water pipeline network component is a water meter, a water pipeline network sensor, a sensor monitoring a valve, a pressure sensor, a temperature sensor, a measurement sensor measuring the chemical composition of the liquid in the water pipeline network, a sensor measuring fluid surface position and/or any other sensor in the water pipeline network.

17. A self-powered IoT water pipeline network component, powered by energy gathered from pressure changes in the water pipeline to which it is mounted on, and the water pipeline network component comprises a piston or a bellow responding to the pressure changes in the pipeline, characterised in that, the water pipeline network component comprises an energy storage mechanism configured to store energy over the course of multiple pressure changes in the pipeline to an energy storage device, and the energy storage device is optionally a spiral spring, which is held back from unwinding by a ratcheting mechanism.

18. A water pipeline network component as claimed in claim 17, characterised in that, multiple pressure increases in the water pipeline network are harvested, the ratchet stopping the cogwheel or axis when water pipeline pressure decreases, but allowing the cogwheel or axis to move and tighten the mechanical spring to store more potential energy, when water pipeline pressure is increased.

19. A water pipeline network component as claimed in claim 17, characterised in that, the water pipeline network component is configured to increase the tension of the spring with pressure variations of about 0.1 bar.

20. A water pipeline network component as claimed in claim 17, characterised in that, the stored potential energy in the spring is released as rotational energy which is configured to spin a geared electro-magnetic generator that generates electrical energy.

21. A water pipeline network component as claimed in claim 20, characterised in that, the electro-magnetic generator is configured to power a reading of the water pipeline network component.

22. A water pipeline network component as claimed in claim 21, characterised in that, the electro-magnetic generator is configured to power a transmission of the reading to the water department.

23. A water pipeline network component as claimed in claim 17, characterised in that, a certain number of rotations of the main ratchet gear or spring is configured to be released, which determines how much potential energy will be released into the electro-magnetic generator.

24. A water pipeline network component as claimed in claim 17, characterised in that, the water department in control of the water pipeline network generates pressure pulses into the water pipeline network configured to power the reading of the water pipeline network component.

25. A water pipeline network component as claimed in claim 17, characterised in that, the water pipeline network component is a water meter and comprises a wireless transmitter configured to transmit the water meter reading to the water department using any of the following: LPWAN, LoRaWAN, cellular network, NB-IoT, LTE-M, Wireless M-Bus.

26. A water pipeline network component as claimed in claim 17, characterised in that, the water pipeline network component is a water meter and the water meter reading can be produced on-site to a display, or via NFC to a user mobile phone on-site.

27. A water pipeline network component as claimed in claim 17, characterised in that, the water pipeline network component is a water meter, and the spring is configured to be manually tightened on site, allowing for a tenant or a technician to power a water meter reading and read the reading from the water meter.

28. A water pipeline network component as claimed in claim 17, characterised in that, the water pipeline network component is a water meter and provides two-way communication to and from the water department, has a rechargeable battery being charged by the energy harvester, and uses ultrasound for water flow measurement.

29. A water pipeline network component as claimed in claim 17, characterised in that, the water pipeline network component is a water meter, a water pipeline network sensor, a sensor monitoring a valve, a pressure sensor, a temperature sensor, a measurement sensor measuring the chemical composition of the liquid in the water pipeline network, a sensor measuring fluid surface position and/or any other sensor in the water pipeline network.

30. A water pipeline network component as claimed in claim 17, characterised in that, the energy harvester is any of the following: piston-spring rolling diaphragm actuator, metal bellow actuator, or Bourdon tube.
